(19) United States
(12) Patent Application Publication
(10) Pub. No.: US 2025/0130075 A1
(43) Pub. Date: Apr. 24, 2025

(54) PROCESSING APPARATUS, DISTRIBUTED ACOUSTIC SENSING SYSTEM, DISTRIBUTED ACOUSTIC SENSING METHOD, AND NON-TRANSITORY COMPUTER READABLE MEDIUM STORING PROGRAM

(71) Applicant: NEC Corporation, Minato-ku, Tokyo (JP)

(72) Inventors: Sakiko MISHIMA, Tokyo (JP); Wataru KOHNO, Tokyo (JP); Reishi KONDO, Tokyo (JP); Tomoyuki HINO, Tokyo (JP)

(73) Assignee: NEC Corporation, Minato-ku, Tokyo (JP)

(21) Appl. No.: 18/835,779

(22) PCT Filed: Feb. 16, 2022
(86) PCT No.: PCT/JP2022/006120

§ 371 Date: Aug. 5, 2024

(51) Int. Cl. G01D 5/353

(52) U.S. Cl. CPC G01D 5/35361; G01D 5/35348

(57) ABSTRACT

A signal acquisition unit acquires a plurality of signal groups acquired based on backscattered light from a plurality of long gauge length sections and a plurality of signal groups acquired based on backscattered light from a plurality of short gauge length sections, which are set in an optical fiber used for distributed acoustic sensing. A signal selection unit selects a long gauge length section based on a first signal feature of each of signal groups of the plurality of long gauge length sections, and selects a plurality of short gauge length sections corresponding to the selected long gauge length section. A section estimation unit determines one short gauge length section, as a section in which an event has occurred, based on a second signal feature of each of signal groups of the plurality of selected short gauge length sections.

### TECHNICAL FIELD

The present invention relates to a processing apparatus, a distributed acoustic sensing system, a distributed acoustic sensing method, and a non-transitory computer readable medium storing a program.

### BACKGROUND ART

Distributed acoustic sensing (DAS) is known as one of optical fiber sensing technologies. In the DAS, when a sound wave hits an optical fiber, light passing through the optical fiber is modulated. Therefore, by detecting the reflected light or the transmitted light, a sound wave or vibration in a remote place can be monitored.

A DAS system generally includes an optical fiber that senses sound or vibration and a detection unit called an interrogator. The interrogator means a “person who inquires”, and applies probe light to an optical fiber, receives reflected light or transmitted light from the optical fiber, and detects a state of a sound wave or vibration acting on the optical fiber (Patent Literatures 1 to 3).

### CITATION LIST

### Patent Literature

Patent Literature 1: Published Japanese Translation of PCT International Publication for Patent Application, No. 2021-511491

Patent Literature 2: Published Japanese Translation of PCT International Publication for Patent Application, No. 2019-518968

Patent Literature 3: Japanese Unexamined Patent Application Publication No. 2012-63146

### SUMMARY OF INVENTION

### Technical Problem

Sensing in the DAS system has a problem that it is difficult to specify a detailed position of a phenomenon to be detected (hereinafter, referred to as an event). In the DAS system, a section having a predetermined gauge length is set in an optical fiber included in an optical cable laid in a target area, a state of sound or vibration generated in the section is measured as a signal, and then it is detected in the vicinity of which section the event has occurred. In this case, in general, a signal obtained from backscattered light from a section having a long gauge length has high intensity and accordingly, a signal having a high signal to noise (SN) ratio is obtained. Therefore, although the occurrence of the event can be easily detected, it is not possible to specify where in the long section the position of the occurrence of the event is because the gauge length is long. On the other hand, a signal obtained from backscattered light from a section having a short gauge length has low intensity and accordingly, a signal having a low SN ratio is obtained. Therefore, since it is difficult to determine whether the signal fluctuation is due to the occurrence of an event or due to noise or the like, event detection accuracy is poor. For this reason, it is difficult to appropriately detect the event even if the gauge length is shortened in order to improve the spatial resolution of the event detection.

The present invention has been made in view of the above circumstances, and it is an object of the present invention to detect the occurrence of an event with high spatial resolution in a distributed acoustic sensing system.

### Solution to Problem

A processing apparatus according to an aspect of the present invention includes: a signal acquisition unit configured to acquire a plurality of signal groups acquired based on backscattered light from a plurality of long gauge length sections and a plurality of signal groups acquired based on backscattered light from a plurality of short gauge length sections, which are set in an optical fiber used for distributed acoustic sensing; a signal selection unit configured to select a long gauge length section based on a first signal feature of each of signal groups of the plurality of long gauge length sections and select a plurality of short gauge length sections corresponding to the selected long gauge length section; and a section estimation unit configured to determine one short gauge length section, as a section in which an event has occurred, based on a second signal feature of each of signal groups of the plurality of selected short gauge length sections.

A distributed acoustic sensing system according to an aspect of the present invention includes: an optical fiber used for sensing; a detection unit configured to output a light pulse to the optical fiber and monitor backscattered light of the light pulse; and a processing apparatus configured to receive a monitoring result of the backscattered light in the detection unit. The processing apparatus includes: a signal acquisition unit configured to acquire a plurality of signal groups acquired based on backscattered light from a plurality of long gauge length sections and a plurality of signal groups acquired based on backscattered light from a plurality of short gauge length sections, which are set in the optical fiber; a signal selection unit configured to select a long gauge length section based on a first signal feature of each of signal groups of the plurality of long gauge length sections and select a plurality of short gauge length sections corresponding to the selected long gauge length section; and a section estimation unit configured to determine one short gauge length section, as a section in which an event has occurred, based on a second signal feature of each of signal groups of the plurality of selected short gauge length sections.

A distributed acoustic sensing method according to an aspect of the present invention includes: acquiring a plurality of signal groups acquired based on backscattered light from a plurality of long gauge length sections and a plurality of signal groups acquired based on backscattered light from a plurality of short gauge length sections, which are set in an optical fiber used for distributed acoustic sensing; selecting a long gauge length section based on a first signal feature of each of signal groups of the plurality of long gauge length sections and selecting a plurality of short gauge length sections corresponding to the selected long gauge length section; and determining one short gauge length section, as a section in which an event has occurred, based on a second signal feature of each of signal groups of the plurality of selected short gauge length sections.

A non-transitory computer readable medium storing a program according to an aspect of the present invention causes a computer to execute: processing for acquiring a plurality of signal groups acquired based on backscattered light from a plurality of long gauge length sections and a plurality of signal groups acquired based on backscattered light from a plurality of short gauge length sections, which are set in an optical fiber used for distributed acoustic sensing; processing for selecting a long gauge length section based on a first signal feature of each of signal groups of a plurality of the long gauge length sections and selecting a plurality of short gauge length sections corresponding to the selected long gauge length section; and processing for determining one short gauge length section, as a section in which an event has occurred, based on a second signal feature of each of signal groups of the plurality of selected short gauge length sections.

### Advantageous Effects of Invention

According to the present invention, it is possible to detect the occurrence of an event with high spatial resolution in the distributed acoustic sensing system.

### BRIEF DESCRIPTION OF DRAWINGS

FIG. 1 is a diagram schematically illustrating the configuration of a distributed acoustic sensing system according to a first example embodiment.

FIG. 2 is a diagram schematically illustrating the configuration of a processing apparatus according to the first example embodiment.

FIG. 3 is a diagram illustrating the configuration of the processing apparatus according to the first example embodiment in more detail.

FIG. 4 is a diagram schematically illustrating a gauge set in an optical fiber.

FIG. 5 is a diagram illustrating an example of a relationship between a gauge length and a signal.

FIG. 6 is a flowchart of an event section determination operation of the distributed acoustic sensing system according to the first example embodiment.

FIG. 7 is a diagram schematically illustrating the configuration of a distributed acoustic sensing system according to a second example embodiment.

FIG. 8 is a flowchart of an event section determination operation of the distributed acoustic sensing system according to the second example embodiment.

FIG. 9 is a diagram schematically illustrating the configuration of a distributed acoustic sensing system according to a third example embodiment.

FIG. 10 is a flowchart of an event section determination operation of the distributed acoustic sensing system according to the third example embodiment.

FIG. 11 is a diagram schematically illustrating the configuration of a distributed acoustic sensing system according to a fourth example embodiment.

FIG. 12 is a flowchart of an event section information update operation of the distributed acoustic sensing system according to the fourth example embodiment.

FIG. 13 is a flowchart of an event section information update operation of the distributed acoustic sensing system according to the fourth example embodiment.

FIG. 14 is a flowchart when similarity between events is determined based on similarity between short gauge length sections corresponding to two adjacent long gauge length sections.

FIG. 15 is a diagram illustrating an example of a short gauge length section shared by two adjacent long gauge length sections.

FIG. 16 is a diagram illustrating an example in which there is no short gauge length section shared by two adjacent long gauge length sections.

### EXAMPLE EMBODIMENT

Hereinafter, example embodiments of the present invention will be described with reference to the diagrams. In the diagrams, the same elements are denoted by the same reference numerals, and repeated description will be omitted as necessary.

### First Example Embodiment

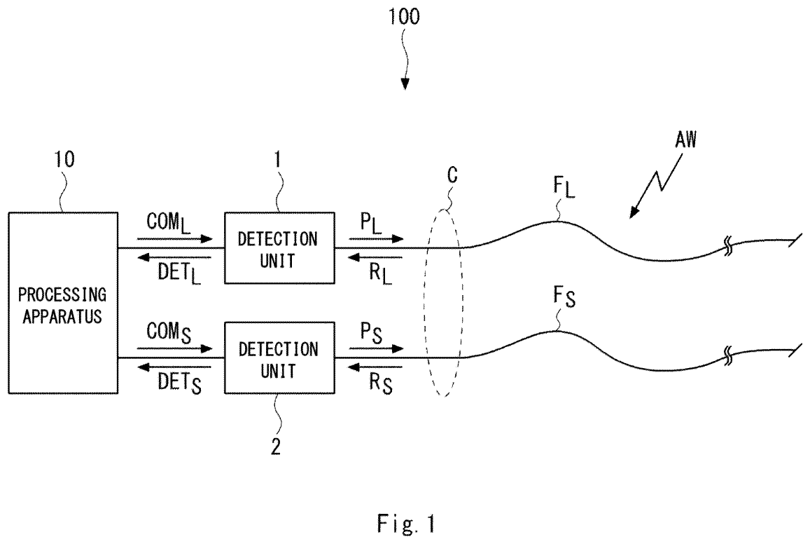

A DAS system according to a first example embodiment will be described. FIG. 1 schematically illustrates the configuration of a DAS system 100 according to the first example embodiment. The DAS system 100 includes detection units 1 and 2, a processing apparatus 10, and optical fibers F_{L} and F_{S}. The processing apparatus 10 is configured to control the detection unit 1 using a control signal COM_{L} and control the detection unit 2 using a control signal COM_{S}. In addition, the processing apparatus 10 is configured to receive a detection signal DET_{L} indicating a detection result from the detection unit 1, receive a detection signal DET_{S} indicating a detection result from the detection unit 2, and perform signal processing required for acoustic sensing on these.

The optical fibers F_{L} and F_{S} are laid on the same or adjacent paths in a region where a sound wave AW is to be sensed, and are, for example, fibers included in an optical cable C such as a submarine cable.

The detection unit 1 is connected to the optical fiber F_{L}, and is configured as a so-called interrogator that outputs a light pulse P_{L} to the optical fiber F_{L} and detects backscattered light R_{L} which is backscattered light in the optical fiber F_{L}. The detection unit 1 outputs the detection signal DET_{L}, which is a detection result of the backscattered light R_{L}, to the processing apparatus 10.

The detection unit 2 is connected to the optical fiber F_{S}, and is configured as a so-called interrogator that outputs a light pulse P_{S} to the optical fiber F_{S} and detects backscattered light R_{S} which is backscattered light in the optical fiber F_{S}. The detection unit 2 outputs the detection signal DET_{S}, which is a detection result of the backscattered light R_{S}, to the processing apparatus 10.

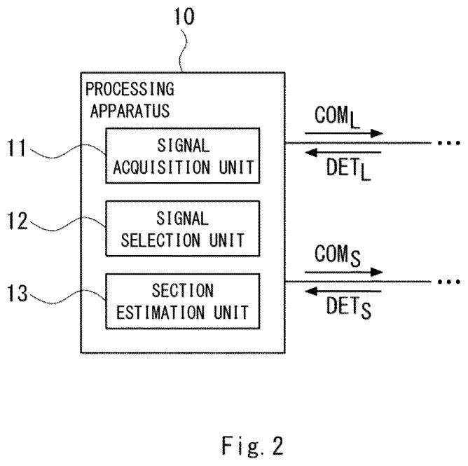

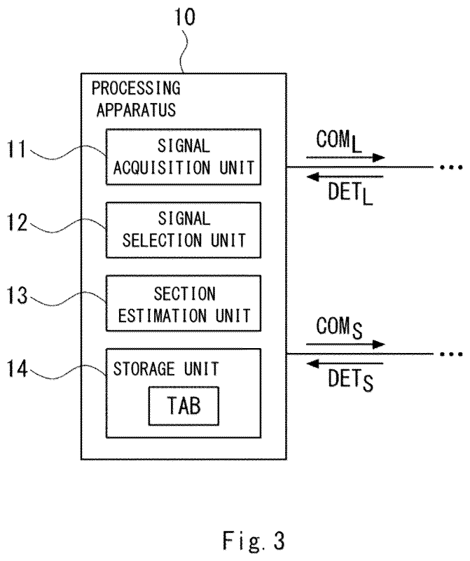

FIG. 2 schematically illustrates the configuration of the processing apparatus 10. FIG. 3 illustrates the configuration of the processing apparatus according to the first example embodiment in more detail. The processing apparatus 10 includes a signal acquisition unit 11, a signal selection unit 12, a section estimation unit 13, and a storage unit 14. The signal acquisition unit 11 receives the detection signals DET_{L} and DET_{S} output from the detection units 1 and 2, performs signal processing for conversion into a data format used for signal processing in the signal selection unit 12, and outputs the processed signal The signal selection unit 12 selects a long gauge to the signal selection unit 12. length section estimated to be closest to the sound source by referring to the received signal group for the long gauge length section, and selects a plurality of short gauge length sections corresponding to the selected long gauge length section based on gauge correspondence information TAB to be described later. The section estimation unit 13 determines the short gauge length section estimated to be closest to the sound source as an event section by referring to the signal group of the selected plurality of short gauge length sections. The storage unit 14 stores the gauge correspondence information TAB in which a short gauge length section corresponds to each long gauge length section, that is, a plurality of short gauge length sections included in one long gauge length section is designated. In addition, the storage unit 14 can also store other kinds of information, and the signal acquisition unit 11, the signal selection unit 12, and the section estimation unit 13 can appropriately read necessary information from the storage unit 14 and write necessary information into the storage unit 14.

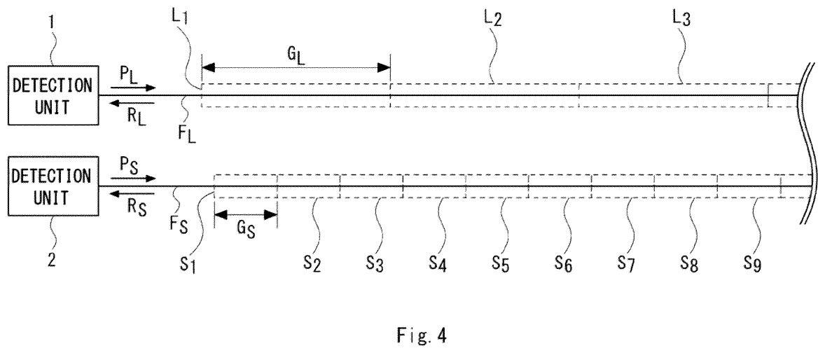

In the present example embodiment, gauges having different lengths are set for the optical fibers F_{L} and F_{S}. FIG. 4 schematically illustrates gauges set for the optical fibers F_{L} and F_{S}. In this example, long gauge length sections L₁ to L_{M} (M is an integer of 2 or more) of a gauge length G_{L} (hereinafter, also referred to as a long gauge length) are set to the optical fibers F_{L} in a direction away from the detection unit 1. Short gauge length sections S₁ to S_{N} (N is an integer of 2 or more) of a gauge length G_{S} (hereinafter, also referred to as a short gauge length) are set to the optical fibers F_{S} in a direction away from the detection unit 2.

The long gauge length G_{L} is longer than the short gauge length G_{S}, and in FIG. 4, as an example, the long gauge length G_{L} is three times the short gauge length G_{S} (G_{L}=3G_{S}). However, this is merely an example, and the long gauge length G_{L} and the short gauge length G_{S} can be set to any values as long as the long gauge length G_{L} is longer than the short gauge length G_{S}. For example, the long gauge length G_{L} can be several tens of meters, and the short gauge length G_{S} can be several tens of centimeters to several meters.

The short gauge length sections may correspond to two adjacent long gauge length sections so as not to overlap each other, or the short gauge length sections may correspond to two adjacent long gauge length sections so as to overlap each other. For example, in FIG. 4, the long gauge length section L₁ may correspond to the short gauge length sections S₁ to S₃, the long gauge length section L₂ may correspond to the short gauge length sections S₄ to S₆, and the long gauge length section L₃ may correspond to the short gauge length sections S₇ to S₉ so as not to overlap each other. For example, in FIG. 4, the short gauge length section S₃ located at the boundary between the long gauge length section L₁ and the long gauge length section L₂ may be shared, and the short gauge length section S₆ located at the boundary between the long gauge length section L₂ and the long gauge length section L₃ may be shared. In this case, the long gauge length section L₂ corresponds to the short gauge length section S₃ shared with the long gauge length section L₁, the short gauge length sections S₄ and S₅, and the short gauge length section S₆ shared with the long gauge length section L₃. In addition, the number of short gauge length sections shared by two adjacent long gauge length sections is not limited to one, and may be any number.

Therefore, the detection unit 1 can receive backscattered light from each of the long gauge length sections L₁ to L_{M} and output the detection result, and the detection unit 2 can receive backscattered light from each of the short gauge length sections S₁ to S_{N} and output the detection result. Then, the processing apparatus 10 can appropriately analyze signals obtained from these detection results.

The DAS system 100 according to the present example embodiment is configured to specify a detailed position of a sound source by using a signal group obtained from backscattered light from a plurality of long gauge length sections and a signal group obtained from backscattered light from a plurality of short gauge length sections in combination.

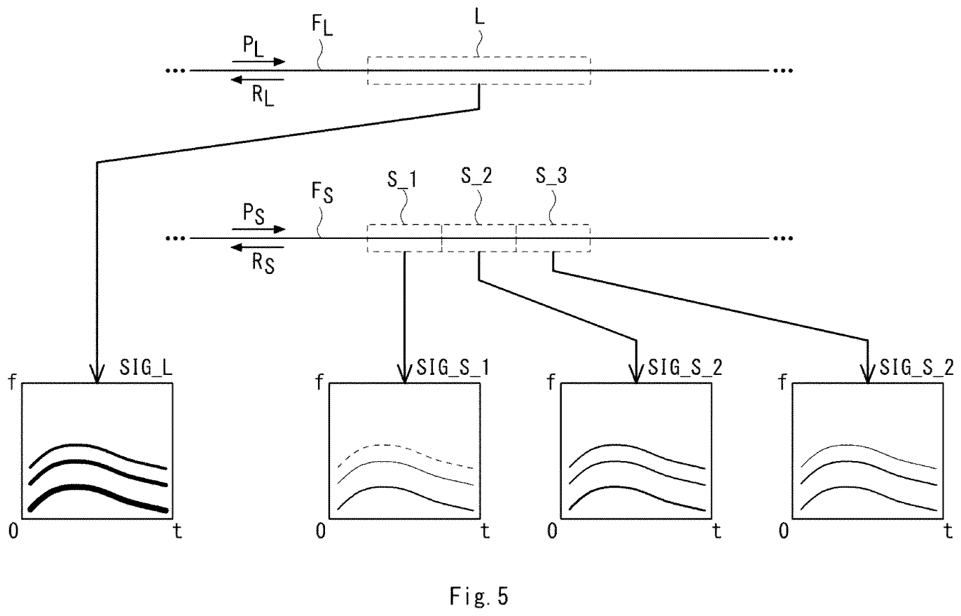

When the backscattered light when the sound wave AW reaches the optical fiber in the DAS system is analyzed, a difference generally occurs between a signal obtained from the backscattered light from the section with a long gauge length and a signal obtained from the backscattered light from the section with a short gauge length. FIG. 5 illustrates an example of the relationship between the gauge length and the signal. Here, as an example, focusing on the long gauge length section L and short gauge length sections S_1 to S_3 corresponding thereto, waveforms in the frequency domain of signals SIG_L and SIG_S_1 to SIGS_3 obtained from these sections are illustrated. Generally, a signal having a high intensity and a high signal to noise (SN) ratio is obtained from the backscattered light from the long gauge length section. Therefore, when the sound wave AW reaches the optical fiber F_{L}, the difference in signal intensity between the adjacent long gauge length sections becomes relatively large, so that the long gauge length section close to the sound source can be easily identified.

On the other hand, a signal having a low intensity and a low SN ratio is generally obtained from the backscattered light from the short gauge length section. For this reason, even if the signal intensity of the backscattered light from the short gauge length section is monitored, a fluctuation in the signal intensity is small when the sound wave reaches and when the signal intensity fluctuates due to a cause other than the sound wave, and it is difficult to determine the signal intensity.

In the DAS system 100, when the sound wave reaches the optical fiber, the long gauge length section closest to the sound source is first specified using the property due to the difference in gauge length, and a signal obtained from the short gauge length section corresponding to the specified long gauge length section, that is, provided at the same position is analyzed to determine the short gauge length section closest to the sound source as an event section. As a result, the DAS system 100 can determine the position (event position) closest to the sound source with high accuracy.

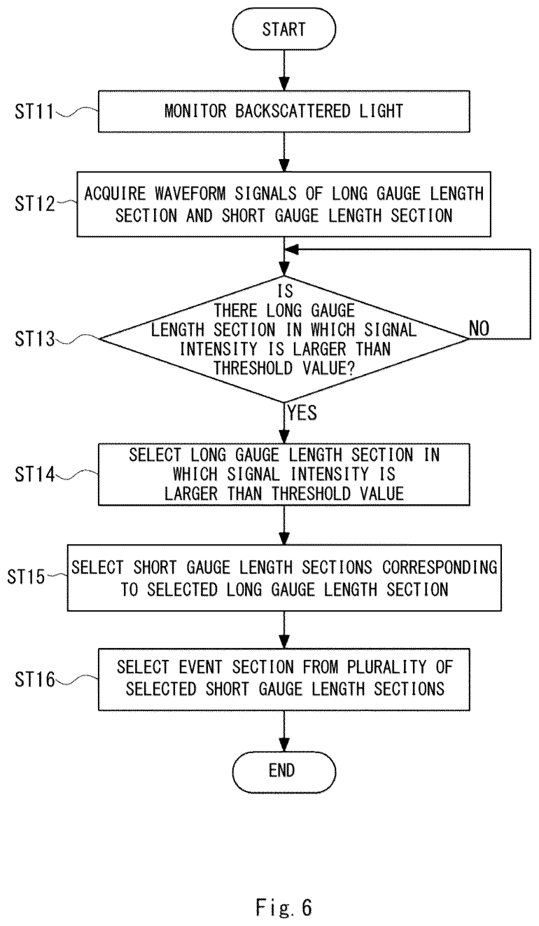

Hereinafter, an event position determination operation in the DAS system 100 will be described. FIG. 6 illustrates a flowchart of an event section determination operation in the DAS system 100.

### Step ST11

The detection unit 1 outputs the light pulse P_{L} to the optical fiber FL to monitor the backscattered light R_{L}. Then, the detection signal DET_{L} obtained by photoelectrically converting the backscattered light R_{L} is output to the processing apparatus 10. The detection unit 2 outputs the light pulse P_{S} to the optical fiber F_{S} and monitors the backscattered light R_{S}. Then, the detection signal DET_{S} obtained by photoelectrically converting the backscattered light R_{S} is output to the processing apparatus 10.

### Step ST12

The signal acquisition unit 11 acquires a signal group of the long gauge length section based on the detection signal DET_{L}, and outputs the acquired signal group to the signal selection unit 12. In addition, the signal acquisition unit 11 acquires a signal group of the short gauge length section based on the detection signal DET_{L}, and outputs the acquired signal group to the signal selection unit 12.

### Step ST13

The signal selection unit 12 monitors the signal group acquired for each long gauge length section, and determines whether there is a long gauge length section whose first signal feature is larger than a threshold value. Here, an example in which the signal intensity of each long gauge length section is used as the first signal feature of each long gauge length section will be described. The signal selection unit 12 monitors a signal group acquired for each long gauge length section, and determines whether there is a long gauge length section in which a fluctuation in signal intensity is larger than a threshold value.

### Step ST14

When there is a long gauge length section in which a fluctuation in the first signal feature is larger than the threshold value, the signal selection unit 12 selects the long gauge length section as a long gauge length section in which an event such as the arrival of the sound wave occurs.

### Step ST15

The signal selection unit 12 selects a plurality of short gauge length sections corresponding to the selected long gauge length section. Here, a plurality of short gauge long sections corresponding to each of the long gauge long sections are determined in advance, and the gauge correspondence information TAB which is the correspondence information may be stored in advance in the storage unit 14 as, for example, a data table. The signal selection unit 12 can select a plurality of short gauge length sections corresponding to the selected long gauge length section with reference to the gauge correspondence information TAB as necessary.

### Step ST16

The section estimation unit 13 selects a short gauge length section (hereinafter, referred to as an event section), in which a sound wave having the highest intensity is estimated to have reached, based on the second signal feature of each of the selected two or more short gauge length sections. Here, an example in which the maximum value of the signal intensity of each short gauge length section is used as the second signal feature of each short gauge length section will be described. The processing apparatus 10 acquires the maximum value of the intensity from each of the waveforms of the two or more short gauge length sections, and selects the short gauge length section having the largest maximum value as an event section.

In the above description, an example of selecting the event section using the maximum value of the intensity of each of the waveforms of the plurality of selected short gauge length sections as the signal feature has been described. However, the event section may be selected using other feature quantities. For example, signal similarity between the selected long gauge length section and each short gauge length section may be used as the signal feature of each short gauge length section.

As a signal to be used, a time waveform signal may be used, or a signal obtained by performing predetermined processing on the time waveform signal may be used. For example, the similarity may be calculated using a signal obtained by applying a low-pass filter to the time waveform signal or a signal obtained by performing processing of suppressing noise. In addition, for example, a signal in the time and frequency domain, a so-called spectrogram, obtained by converting a time waveform signal by Fourier transform or Constant Q Conversion (CQT) may be used. In this case, not only the converted signal itself but also a signal obtained by performing predetermined signal processing on the converted signal, such as a signal obtained by binarizing the intensity of the converted waveform signal by performing discrimination processing using a predetermined threshold value or a signal obtained by applying an edge enhancement filter in order to enhance a portion where the intensity change is steep, may be used. In addition, a so-called spectrogram may be used.

For the calculation of the similarity, an index indicating a difference between the waveform signal acquired for the selected long gauge length section and the waveform signal acquired for each short gauge length section may be used. When the signal feature is a multidimensional quantity such as a distribution of data points or a vector quantity, various indices such as a cross-correlation, a correlation coefficient, a Mahalanobis distance, a cosine distance, and a Pearson product-moment correlation coefficient can be used as indices indicating the difference. In addition, when the signal feature is a scalar quantity, an index such as a difference between two values or an absolute value of the difference can be used.

In addition, as the signal feature, a principal component obtained by performing principal component analysis on a time waveform signal or a signal in the time and frequency domain or a Mel frequency cepstral coefficient of a signal in the time and frequency domain may be used.

As described above, according to the present configuration, the detailed position of the event section can be narrowed down by specifying the outline position where the event has occurred in the long gauge length section and determining the event section from the short gauge length section corresponding to the specified long gauge length section. That is, the event section can be determined with high spatial resolution.

As described above, in the short gauge length section, the SN ratio of the signal obtained by the occurrence of the event is low. For this reason, it is generally difficult to determine whether the signal fluctuation is caused by the event or the influence of noise or the like. However, according to this configuration, the outline position where the event has occurred is specified using the long gauge length section in which a signal having a high SN ratio is obtained. Therefore, since it is possible to determine that the intensity fluctuation appearing in the signal of the short gauge length section corresponding to the specified long gauge length section is due to the event, it is possible to accurately determine the short gauge length section in which the event has occurred.

### Second Example Embodiment

In the first example embodiment, an example in which a long gauge length section is set in one of the two optical fibers and a short gauge length section is set in the other optical fiber has been described. However, other configurations can be adopted as long as a signal group of the long gauge length section and a signal group of the short gauge length section can be obtained. Hereinafter, another configuration of the DAS system capable of obtaining a signal group of the long gauge length section and a signal group of the short gauge length section will be described.

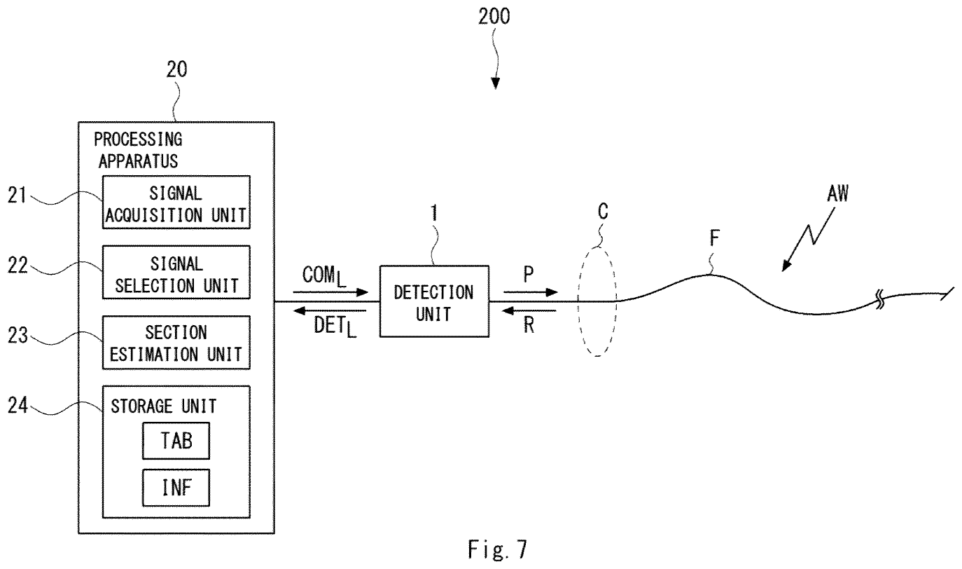

FIG. 7 schematically illustrates the configuration of a DAS system 200 according to the second example embodiment. The DAS system 200 includes a processing apparatus 2, a detection unit 1, and an optical fiber F. Since the detection unit 1 is similar to that of the first example embodiment, the description thereof will be omitted.

In the DAS system 200, similarly to the DAS system 100, the detection unit 1 can output the light pulse P to the optical fiber F and monitor the backscattered light R from the gauge section having a predetermined gauge length set in the optical fiber F. As a result, it is possible to acquire a signal group obtained for a plurality of gauge sections.

The processing apparatus 2 is configured to be able to convert the acquired signal group into signals in different gauge length sections by performing predetermined signal processing. A signal acquisition unit 21, a signal selection unit 22, a section estimation unit 23, and a storage unit 24 of the processing apparatus 2 correspond to the signal acquisition unit 11, the signal selection unit 12, the section estimation unit 13, and the storage unit 14 of the processing apparatus 1, respectively.

In this configuration, a long gauge length section can be set in the optical fiber F, and a signal group obtained for the long gauge length section can be converted into a signal group for the short gauge length section by signal processing.

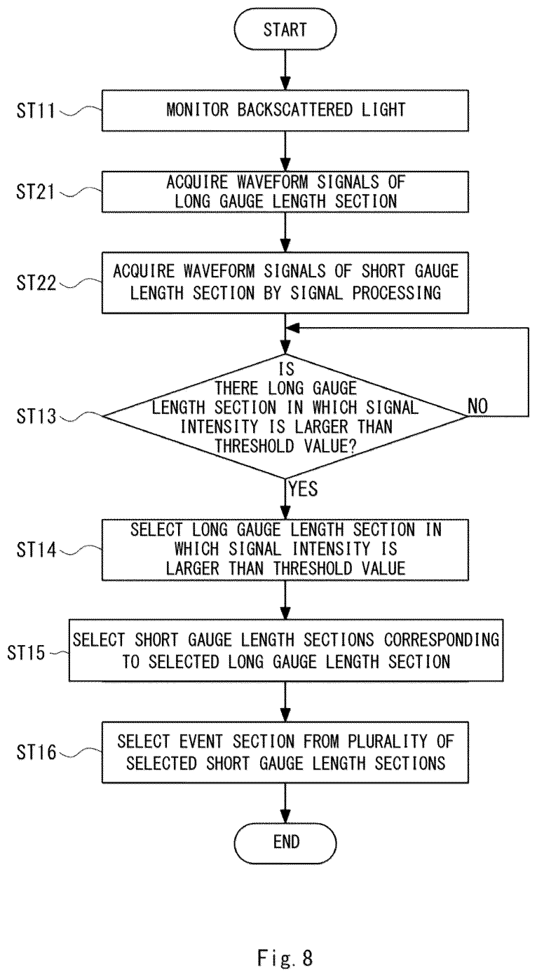

Hereinafter, an operation of the DAS system 200 will be described. FIG. 8 illustrates a flowchart of an event section determination operation of the DAS system 200 according to the second example embodiment. In FIG. 8, step ST12 in FIG. 6 is replaced with steps ST21 and ST22.

### Step ST21

The signal acquisition unit 21 acquires a signal group corresponding to the long gauge length section.

### Step ST22

The signal acquisition unit 21 acquires a signal group corresponding to the short gauge length section by performing signal processing on a signal group corresponding to the long gauge length section based on signal processing conditions INF read from the storage unit 24.

Since the other steps ST11 and ST13 to ST16 are similar to those in FIG. 6, the description thereof will be omitted.

The signal processing conditions in this configuration can be determined by performing initial setting processing as follows. First, a known sound source is set in advance in the vicinity of the optical fiber F, and a known sound wave is emitted to the optical fiber F to acquire a signal group for a long gauge length section. Thereafter, a short gauge length section is set in the optical fiber, and a known sound wave is emitted again to acquire a signal group for the short gauge length section. Then, by comparing the two obtained signal groups and performing initial setting processing for setting conditions under which a signal in the long gauge length section can be converted to obtain a signal in the short gauge length section, the signal processing conditions can be acquired and stored in the storage unit 24 as the signal processing conditions INF.

In addition, a short gauge length section may be set in the optical fiber F, and a signal group obtained for the short gauge length section may be converted into a signal group for the long gauge length section by signal processing. Even in this case, the signal processing conditions can be acquired in the same manner as described above.

As a modified example of the DAS system 200, a signal group for the long gauge length section and a signal group for the short gauge length section can be acquired by changing the detection of backscattered light by the detection unit. For example, two light receiving units may be provided in the detection unit, and backscattered light from the optical fiber F may be distributed to the two light receiving units. In this case, by physically splitting the backscattered light into two without using signal processing, it is possible to acquire a signal group for the long gauge length section from the signal output from one light receiving unit and acquire a signal group for the short gauge length section from the signal output from the other light receiving unit. Therefore, similarly, each time a light pulse is output, a signal group for the long gauge length section and a signal group for the short gauge length section can be simultaneously acquired from the signal output from the other light receiving unit.

As described above, according to the DAS system according to the second example embodiment, the event section can be determined with high spatial resolution as in the first example embodiment.

### Third Example Embodiment

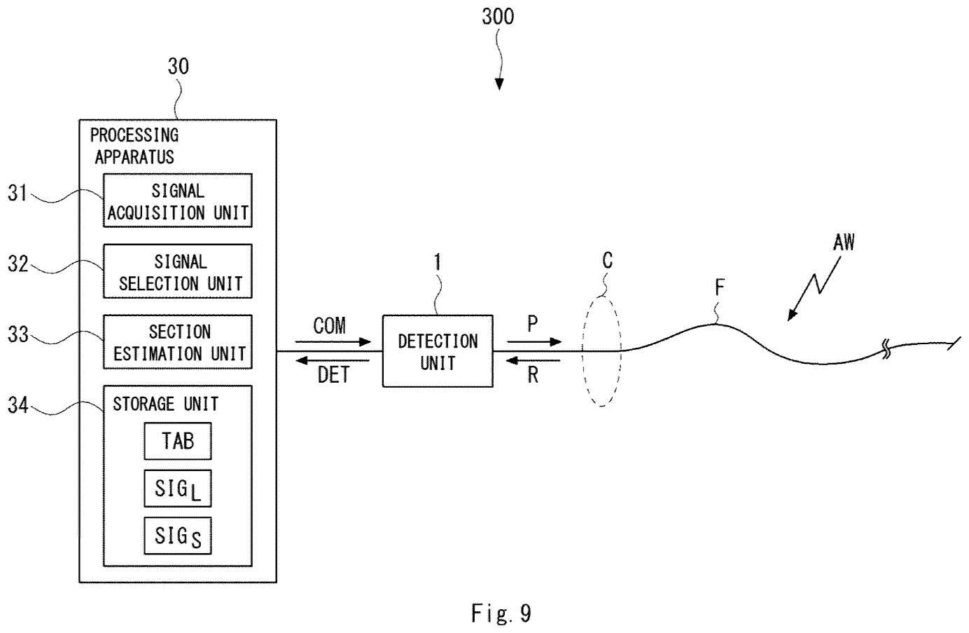

A DAS system according to a third example embodiment will be described. A DAS system 300 according to the third example embodiment is configured as a modified example of the DAS system 200. FIG. 9 schematically illustrates the configuration of the DAS system 300 according to the third example embodiment. The DAS system 300 includes a processing apparatus 3, a detection unit 1, and an optical fiber F. Since the detection unit 1 and the optical fiber F are similar to those of the DAS system 200, the description thereof will be omitted.

The processing apparatus 3 is configured to be able to acquire a signal group in the long gauge length section and a signal group in the short gauge length section by switching the gauge length as described later. A signal acquisition unit 31, a signal selection unit 32, a section estimation unit 33, and a storage unit 34 of the processing apparatus 3 correspond to the signal acquisition unit 11, the signal selection unit 12, the section estimation unit 13, and the storage unit 14 of the processing apparatus 1, respectively.

In the DAS system 300, the long gauge length section and the short gauge length section are alternately set in the optical fiber F in a time division manner. That is, processing for acquiring the signal group in a state in which the long gauge length section is set and processing for acquiring the signal group in a state in which the short gauge length section is set can be alternately performed.

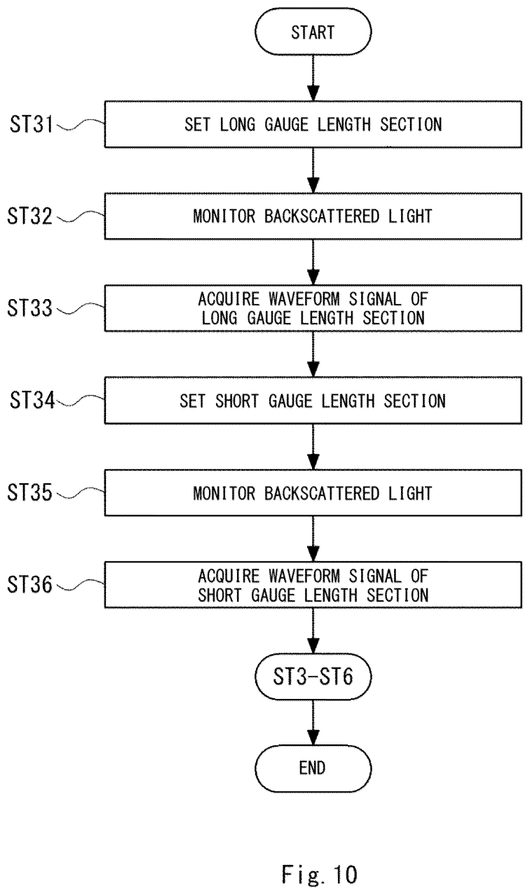

Hereinafter, an operation of the DAS system 300 will be described. FIG. 10 illustrates a flowchart of an event section determination operation of the DAS system 300 according to the third example embodiment. In FIG. 10, steps ST11 and ST12 in FIG. 6 are replaced with steps ST31 to ST36.

### Step ST31

First, the signal acquisition unit 31 sets a plurality of long gauge length sections in the optical fiber F.

### Step ST32

The detection unit 1 outputs the light pulse P to the optical fiber F to monitor the backscattered light R. Then, the detection signal DET obtained by photoelectrically converting the backscattered light R is output to the processing apparatus 10.

### Step ST33

The signal acquisition unit 31 acquires a signal group of the long gauge length section based on the detection signal DET, and stores the acquired signal group in, for example, the storage unit 34 as long gauge length section signal group information SIG_{L}.

### Step ST34

The signal acquisition unit 31 sets a plurality of short gauge length sections in the optical fiber F by switching the gauge length.

### Step ST35

The detection unit 1 outputs the light pulse P to the optical fiber F to monitor the backscattered light R. Then, the detection signal DET obtained by photoelectrically converting the backscattered light R is output to the processing apparatus 10.

### Step ST36

The signal acquisition unit 31 acquires a signal group of the short gauge length section based on the detection signal DET, and stores the acquired signal group in, for example, the storage unit 34 as short gauge length section signal group information SIG_{S}.

Since the other steps ST13 to ST16 are similar to those in FIG. 6, the description thereof will be omitted.

In this configuration, for example, when a sound wave from the sound source is continuously emitted or intermittently emitted, the sound wave from the same sound source can be sampled multiple times. As a result, it is possible to acquire a signal group for the long gauge length section and a signal group for the short gauge length section for a similar or approximate sound wave by setting the timing of switching the gauge length sufficiently short although not simultaneous in time.

As described above, according to the DAS system according to the third example embodiment, the event section can be determined with high spatial resolution as in the first and second example embodiments.

### Fourth Example Embodiment

In the first example embodiment, only one long gauge length section is selected, and a plurality of short gauge length sections close to the sound source is determined from a plurality of short gauge length sections corresponding to the selected one long gauge length section. However, when an event occurs in two long gauge length sections, a plurality of short gauge length sections close to the sound source may be determined from short gauge length sections corresponding to these two long gauge length sections. In the present example embodiment, a DAS system that determines a plurality of short gauge length sections close to a sound source from the short gauge length sections corresponding to the two long gauge length sections as described above will be described.

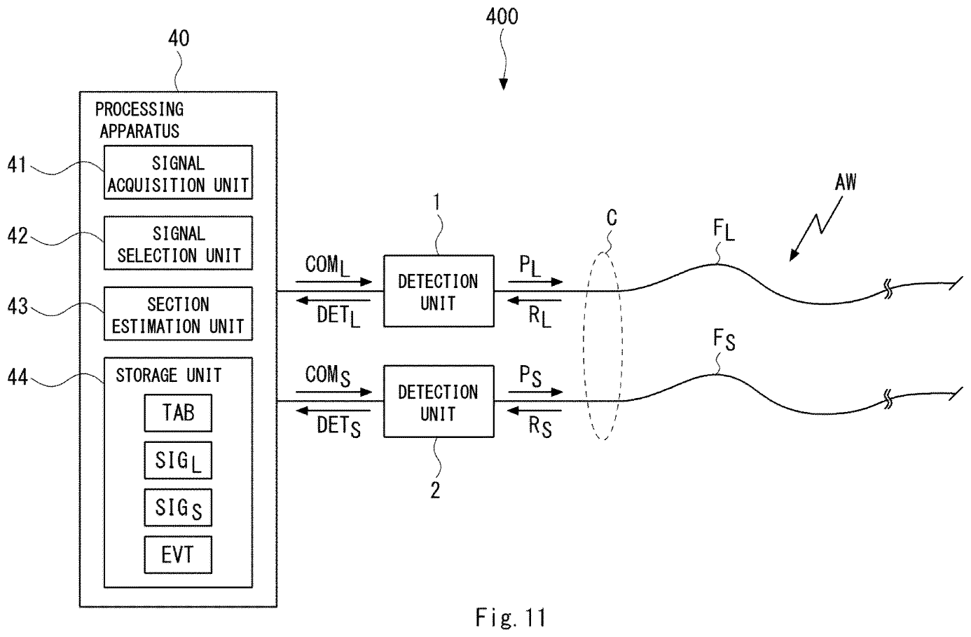

FIG. 11 schematically illustrates the configuration of a DAS system 400 according to a fourth example embodiment. The DAS system 400 has a configuration in which the processing apparatus 1 of the DAS system 100 is replaced with a processing apparatus 4. Since the detection units 1 and 2 and the optical fibers F_{L} and F_{S} are similar to those of the DAS system 100, the description thereof will be omitted.

A signal acquisition unit 41, a signal selection unit 42, a section estimation unit 43, and a storage unit 44 of the processing apparatus 4 correspond to the signal acquisition unit 11, the signal selection unit 12, the section estimation unit 13, and the storage unit 14 of the processing apparatus 1, respectively.

Hereinafter, an operation of the DAS system 400 will be described. In the DAS system 400, after the event section determination operation illustrated in FIG. 6 is performed, when event sections exist in adjacent long gauge length sections, it is determined whether the event sections are the same event, that is, caused by the same sound wave, and processing for updating the event section information is performed as necessary.

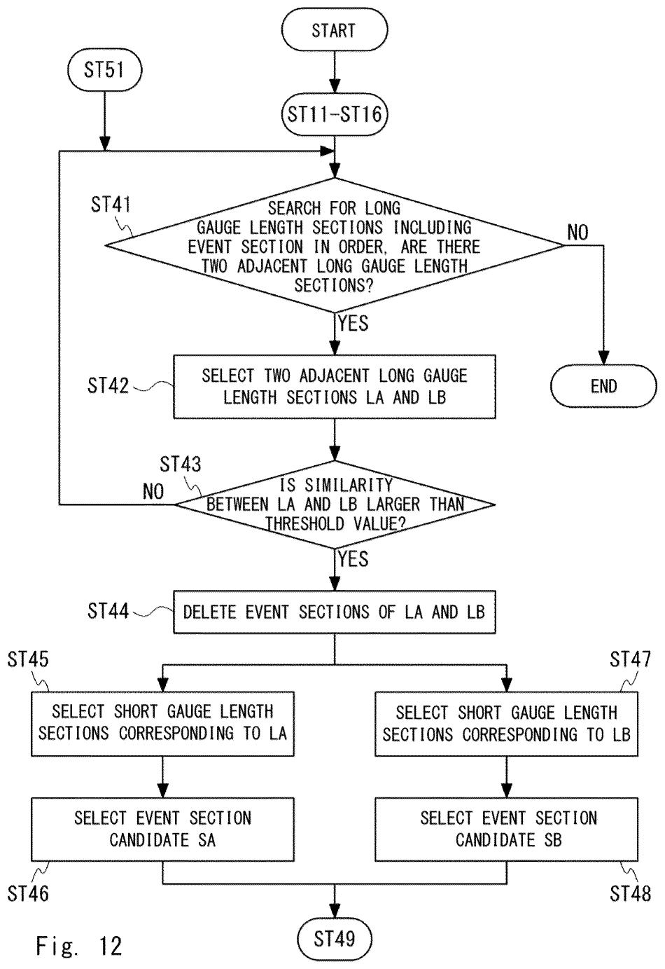

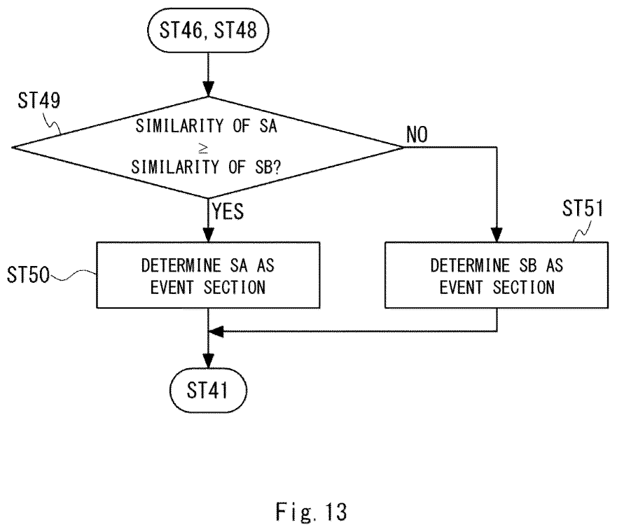

FIGS. 12 and 13 illustrate flowcharts of an event section information update operation of the DAS system 400 according to the fourth example embodiment. Each step in FIGS. 12 and 13 is performed after the end of steps ST11 to ST16 in FIG. 6.

In addition, in this configuration, long gauge length section signal group information SIG_{L}, short gauge length section signal group information SIG_{S}, and event section information EVT that is information indicating a short gauge length section that is an event section, which are acquired in advance by performing steps ST11 to ST16 in FIG. 6, are stored.

### Step ST41

The signal acquisition unit 41 searches for a portion where an event section exists in each of two adjacent long gauge length sections, in order from the detection unit 1 side, by referring to the event section information EVT and the gauge correspondence information TAB. When there is no portion where an event section exists in each of the two adjacent long gauge length sections, the process ends.

### Step ST42

When there is a portion where an event section exists in each of the two adjacent long gauge length sections, the signal selection unit 42 selects found two adjacent long gauge length sections LA and LB, and transmits the selection result to the section estimation unit 43.

### Step ST43

As described in the first example embodiment, the section estimation unit 43 calculates the similarity between the long gauge length sections LA and LB, and determines whether the calculated similarity is larger than a predetermined threshold value. The similarity between the long gauge length sections LA and LB is calculated, and the process returns to step ST41 when the calculated similarity is equal to or less than the predetermined threshold value. Therefore, when the similarity is small, it can be understood that the signal groups of the long gauge length sections LA and LB are dissimilar and the long gauge length sections LA and LB are determined to be different events.

### Step ST44

When the similarity calculated in step ST43 is larger than the predetermined threshold value, the section estimation unit 43 deletes the event sections of the long gauge length sections LA and LB. Specifically, the section estimation unit 43 accesses the storage unit 44 and performs processing for deleting the event sections of the long gauge length sections LA and LB from the event section information EVT.

### Step ST45

The signal selection unit 42 selects a plurality of short gauge length sections corresponding to the long gauge length section LA.

### Step ST46

The section estimation unit 43 selects an event section candidate SA, which is a short gauge length section in which a sound wave having the highest intensity is estimated to have reached, based on the signal feature of each of the plurality of short gauge length sections corresponding to the long gauge length section LA.

### Step ST47

The signal selection unit 42 selects a plurality of short gauge length sections corresponding to the long gauge length section LB.

### Step ST48

The section estimation unit 43 selects an event section candidate SB, which is a short gauge length section in which a sound wave having the highest intensity is estimated to have reached, based on the signal feature of each of the plurality of short gauge length sections corresponding to the long gauge length section LB.

### Step ST49

The section estimation unit 43 calculates similarity between the long gauge length section LA and the event section candidate SA and similarity between the long gauge length section LB and the event section candidate SB. Then, it is determined whether the similarity between the long gauge length section LA and the event section candidate SA is equal to or greater than the similarity between the long gauge length section LB and the event section candidate SB.

### Step ST50

When the similarity between the long gauge length section LA and the event section candidate SA is equal to or greater than the similarity between the long gauge length section LB and the event section candidate SB, the event section candidate SA is determined as an event section, and the event section information EVT is updated. Thereafter, the process returns to step ST41.

### Step ST51

When the similarity between the long gauge length section LA and the event section candidate SA is smaller than the similarity between the long gauge length section LB and the event section candidate SB, the event section candidate

SB is determined as an event section, and the event section information EVT is updated. Thereafter, the process returns to step ST41.

By performing the above steps ST41 to ST51, when there are event sections caused by the same event in a plurality of long gauge sections, it is possible to delete overlapping event sections and aggregate the event sections into event sections caused by one event.

In addition, since dissimilar event sections can be left as they are, it is possible to appropriately hold information of event sections caused by different events.

In FIGS. 12 and 13, the similarity between the events is determined based on the similarity between the waveform signals of the two adjacent long gauge length sections, but the similarity may be determined based on the similarity between the short gauge length sections corresponding to the two adjacent long gauge length sections. Hereinafter, a specific description will be given.

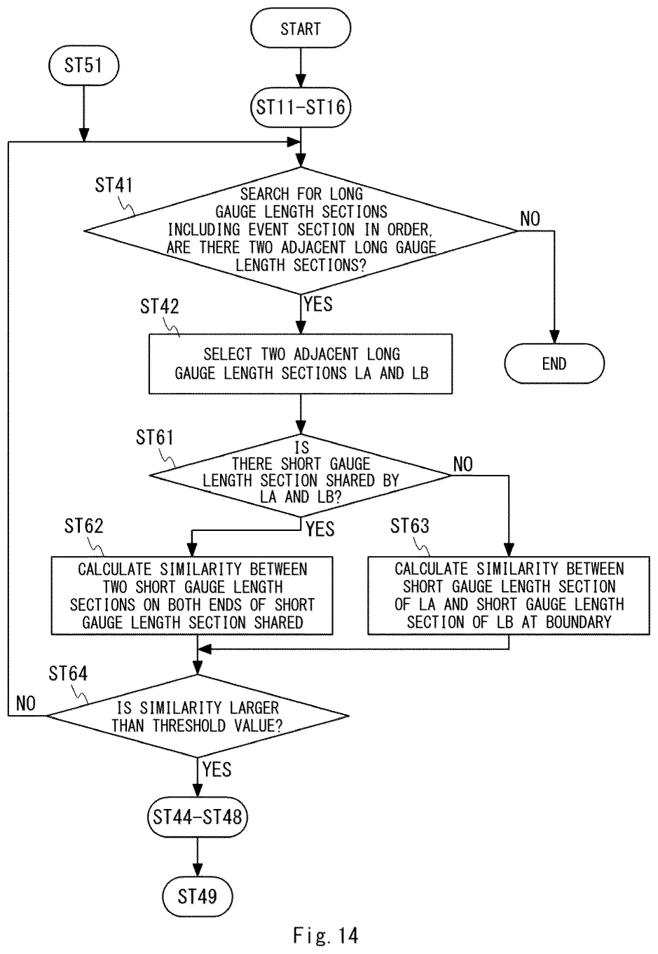

FIG. 14 illustrates a flowchart when similarity between events is determined based on similarity between short gauge length sections corresponding to two adjacent long gauge length sections. In FIG. 14, step ST43 in FIG. 12 is replaced with steps ST61 to ST64.

### Step ST61

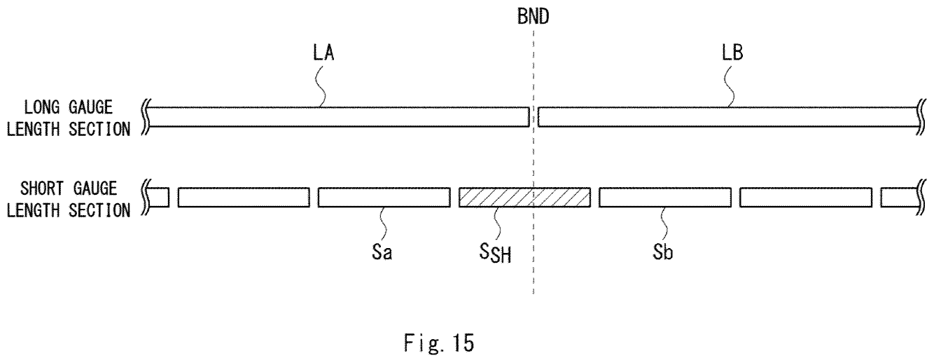

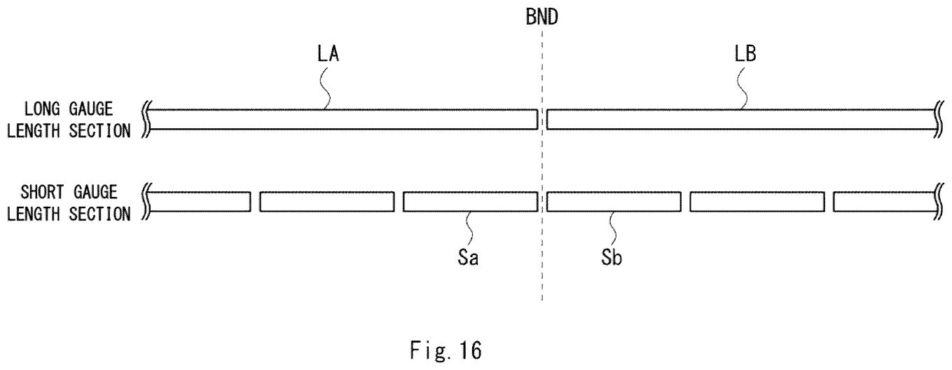

The section estimation unit 43 determines whether there is a short gauge length section shared by the long gauge length sections LA and LB. Here, sharing of the short gauge length section will be described. FIG. 15 illustrates an example in which the long gauge length sections LA and LB have a shared short gauge length section. In this example, a short gauge length section S_{SH} existing across a boundary BND between the long gauge length sections LA and LB is a short gauge length section corresponding to both the long gauge length sections LA and LB. FIG. 16 illustrates an example in which there is no short gauge length section shared by the long gauge length sections LA and LB. In this example, each of the long gauge length sections LA and LB corresponds to its own short gauge length section, and there is no short gauge length section that overlaps and corresponds to both sections.

### Step ST62

When there is a short gauge length section shared by the long gauge length sections LA and LB, the section estimation unit 43 calculates similarity between the short gauge length section Sa corresponding to the long gauge length section LA and the short gauge length section Sb corresponding to the long gauge length section LB, which are adjacent to the shared short gauge length section S_{SH}. In other words, the short gauge length section Sa is a short gauge length section closest to the long gauge length section LB other than the shared short gauge length section S_{SH} among the plurality of short gauge length sections corresponding to the long gauge length section LA. The short gauge length section Sb is a short gauge length section closest to the long gauge length section LA other than the shared short gauge length section S_{SH} among the plurality of short gauge length sections corresponding to the long gauge length section LB.

### Step ST63

When there is no short gauge length section shared by the long gauge length sections LA and LB, the section estimation unit 43 calculates similarity between the short gauge length section Sa adjacent to the long gauge length section LB, among the plurality of short gauge length sections corresponding to the long gauge length section LA, and the short gauge length section b adjacent to the long gauge length section LA, among the plurality of short gauge length sections corresponding to the long gauge length section LB.

### Step ST64

The section estimation unit 43 determines whether the similarity between the short gauge length section Sa and the short gauge length section Sb is larger than a predetermined threshold value. When the similarity is larger than the predetermined threshold value, the process proceeds to step ST44, and when the similarity is equal to or less than the predetermined threshold value, the process returns to step ST41.

Since the other steps are the same as those in FIGS. 12 and 13, the description thereof will be omitted.

Therefore, also in this case, similarly to FIGS. 12 and 13, the short gauge length sections based on the same event can be aggregated into one.

Although the above description has been given as a modified example of the DAS system 100 according to the first example embodiment, this is merely an example. It is needless to say that the present invention can be applied to the DAS systems according to the second and third example embodiments as long as the signal group of the long gauge length section and the signal group of the short gauge length section can be used.

### Other Example Embodiments

In addition, the present invention is not limited to the example embodiments described above and can be appropriately changed without departing from the gist of the present invention. For example, in the above example embodiments, the similarity has been described, but the similarity may be an index indicating similarity when the index is large and dissimilarity when the index is small, or may be an index indicating dissimilarity when the index is large and similarity when the index is small.

In the above example embodiments, the step of determining the magnitude relationship between the two values a and b has been described. However, when the values a and b are equal, it may be determined that the value a is large or the value b is large as necessary. In other words, it may be determined whether the value a is larger than the value b (that is, the value b is equal to or less than the value a), or it may be determined whether the value a is equal to or greater than the value b (that is, the value b is smaller than the value a).

In the above example embodiments, the present invention has been described as a hardware configuration, but the present invention is not limited thereto. The present invention can also realize the processes in the processing apparatus by causing a central processing unit (CPU) to execute a computer program. In addition, the program described above can be stored using various types of non-transitory computer readable media and supplied to the computer. The non-transitory computer readable media include various types of tangible storage media. Examples of the non-transitory computer readable media include a magnetic recording medium (for example, a flexible disk, a magnetic tape, or a hard disk drive), a magneto-optical recording medium (for example, a magneto-optical disc), a CD-read only memory (ROM) CD-R, a CD-R/W, and a semiconductor memory (for example, a mask ROM, a programmable ROM (PROM), an erasable PROM (EPROM), a flash ROM, and a random access memory (RAM)). In addition, the program may be supplied to the computer through various types of transitory computer readable media. Examples of transitory computer readable media include electrical signals, optical signals, and electromagnetic waves. The transitory computer readable media can supply the programs to the computer through a wired communication path such as an electric wire and an optical fiber or a wireless communication path.

Although the present invention has been described above, the present invention can also be described as follows.

(Supplementary Note 1) A processing apparatus, including: a signal acquisition unit configured to acquire a plurality of signal groups acquired based on backscattered light from a plurality of long gauge length sections and a plurality of signal groups acquired based on backscattered light from a plurality of short gauge length sections, which are set in an optical fiber used for distributed acoustic sensing; a signal selection unit configured to select a long gauge length section based on a first signal feature of each of signal groups of a plurality of the long gauge length sections and select a plurality of short gauge length sections corresponding to the selected long gauge length section; and a section estimation unit configured to determine one short gauge length section, as a section in which an event has occurred, based on a second signal feature of each of signal groups of the plurality of selected short gauge length sections.

(Supplementary Note 2) The processing apparatus according to Supplementary Note 1, wherein the signal selection unit compares each signal of the plurality of selected short gauge length sections with a signal of the selected long gauge length section, and determines a short gauge length section having a signal closest to the signal of the selected long gauge length section as a section in which the event has occurred.

(Supplementary Note 3) The processing apparatus according to Supplementary Note 2, wherein the signal selection unit uses, as the signal, any one of a time waveform signal, a waveform signal obtained by applying a frequency filter to the time waveform signal, a waveform signal obtained by performing processing for suppressing noise of the time waveform signal, a signal obtained by Fourier transforming the time waveform signal, a signal obtained by converting the time waveform signal by Constant Q Conversion (CQT), and a spectrogram acquired from the time waveform signal.

(Supplementary Note 4) The processing apparatus according to Supplementary Note 1, wherein the signal selection unit determines a section in which the event has occurred based on a principal component obtained by performing principal component analysis on a time waveform signal of each of the plurality of selected short gauge length sections or a waveform signal obtained by converting the time waveform signal or based on a Mel frequency cepstral coefficient of the time waveform signal of each of the plurality of selected short gauge length sections or a waveform signal obtained by converting the time waveform signal.

(Supplementary Note 5) The processing apparatus according to any one of Supplementary Notes 1 to 4, wherein the signal selection unit selects a long gauge length section whose first signal feature is larger than a first threshold value.

(Supplementary Note 6) The processing apparatus according to any one of Supplementary Notes 1 to 5, wherein the signal selection unit determines one of the plurality of selected short gauge length sections having a maximum first signal feature as a section in which the event has occurred.

(Supplementary Note 7) The processing apparatus according to Supplementary Note 1, wherein the signal selection unit selects a long gauge length section whose first signal feature is larger than a first threshold value, and determines one of the plurality of selected short gauge length sections having a maximum first signal feature as a section in which the event has occurred.

(Supplementary Note 8) The processing apparatus according to any one of Supplementary Notes 1 to 7, wherein the plurality of long gauge length sections are set in a first optical fiber, and the plurality of short gauge length sections are set in a second optical fiber having a path that is the same as or close to that of the first optical fiber.

(Supplementary Note 9) The processing apparatus according to any one of Supplementary Notes 1 to 7, wherein the signal acquisition unit acquires a signal group by setting one the plurality of long gauge length sections and the plurality of short gauge length sections in one optical fiber, and acquires a signal group of the other of the plurality of long gauge length sections and the plurality of short gauge length sections by performing predetermined signal processing on the acquired signal group.

(Supplementary Note 10) The processing apparatus according to any one of Supplementary Notes 1 to 7, wherein the signal acquisition unit alternately performs processing for acquiring signal groups of the plurality of long gauge length sections by setting the plurality of long gauge length sections in one optical fiber and processing for acquiring signal groups of the plurality of short gauge length sections by setting the plurality of short gauge length sections in the one optical fiber.

(Supplementary Note 11) The processing apparatus according to any one of Supplementary Notes 1 to 10, wherein after a section in which the event has occurred is determined, two adjacent long gauge length sections including the section in which the event has occurred are searched for, when signals of the two adjacent long gauge length sections are similar, a plurality of corresponding short gauge length sections are selected for each of the two adjacent long gauge length sections, one short gauge length section is selected as an event section candidate based on a second signal feature of each signal group of the plurality of selected short gauge length sections, a similarity indicating a degree of similarity between a signal of a first long gauge length section, which is one of the two adjacent long gauge length sections, and a signal of an event candidate of the first long gauge length section is compared with a similarity indicating a degree of similarity between a signal of a second long gauge length section, which is the other of the two adjacent long gauge length sections, and a signal of an event candidate of the second long gauge length section, and instead of the section in which the event has occurred of the first and second long gauge length sections, the event candidate of a long gauge section having the larger similarity is newly determined as a section in which the event has occurred.

(Supplementary Note 12) The processing apparatus according to any one of Supplementary Notes 1 to 10, wherein after a section in which the event has occurred is determined, two adjacent long gauge length sections including the section in which the event has occurred are searched for, one short gauge length section close to the other long gauge length section is selected from each of the two adjacent long gauge length sections, when signals of two short gauge length sections selected from the two adjacent long gauge length sections are similar, a plurality of corresponding short gauge length sections are selected for each of the two adjacent long gauge length sections, one short gauge length section is selected as an event section candidate based on a signal feature of each signal group of the plurality of selected short gauge length sections, a similarity indicating a degree of similarity between a signal of a first long gauge length section, which is one of the two adjacent long gauge length sections, and a signal of an event candidate of the first long gauge length section is compared with a similarity indicating a degree of similarity between a signal of a second long gauge length section, which is the other of the two adjacent long gauge length sections, and a signal of an event candidate of the second long gauge length section, and instead of the event occurrence section of the first and second long gauge length sections, the event candidate of a long gauge section having the larger similarity is newly determined as a section in which the event has occurred.

(Supplementary Note 13) A distributed acoustic sensing system, including: an optical fiber used for sensing; a detection unit configured to output a light pulse to the optical fiber and monitor backscattered light of the light pulse; and a processing apparatus configured to receive a monitoring result of the backscattered light in the detection unit, wherein the processing apparatus includes: a signal acquisition unit configured to acquire a plurality of signal groups acquired based on backscattered light from a plurality of long gauge length sections and a plurality of signal groups acquired based on backscattered light from a plurality of short gauge length sections, which are set in the optical fiber; a signal selection unit configured to select a long gauge length section based on a first signal feature of each of signal groups of a plurality of the long gauge length sections and select a plurality of short gauge length sections corresponding to the selected long gauge length section; and a section estimation unit configured to determine one short gauge length section, as a section in which an event has occurred, based on a second signal feature of each of signal groups of the plurality of selected short gauge length sections.

(Supplementary Note 14) A distributed acoustic sensing method, including: acquiring a plurality of signal groups acquired based on backscattered light from a plurality of long gauge length sections and a plurality of signal groups acquired based on backscattered light from a plurality of short gauge length sections, which are set in an optical fiber used for distributed acoustic sensing; selecting a long gauge length section based on a first signal feature of each of signal groups of a plurality of the long gauge length sections and selecting a plurality of short gauge length sections corresponding to the selected long gauge length section; and determining one short gauge length section, as a section in which an event has occurred, based on a second signal feature of each of signal groups of the plurality of selected short gauge length sections.

(Supplementary Note 15) A non-transitory computer readable medium storing a program causing a computer to execute: processing for acquiring a plurality of signal groups acquired based on backscattered light from a plurality of long gauge length sections and a plurality of signal groups acquired based on backscattered light from a plurality of short gauge length sections, which are set in an optical fiber used for distributed acoustic sensing; processing for selecting a long gauge length section based on a first signal feature of each of signal groups of a plurality of the long gauge length sections and selecting a plurality of short gauge length sections corresponding to the selected long gauge length section; and processing for determining one short gauge length section, as a section in which an event has occurred, based on a second signal feature of each of signal groups of the plurality of selected short gauge length sections.

### REFERENCE SIGNS LIST

100, 200, 300, 400 DAS SYSTEM
1, 2 DETECTION UNIT
10, 20, 30, 40 PROCESSING APPARATUS
11, 21, 31, 41 SIGNAL ACQUISITION UNIT
12, 22, 32, 42 SIGNAL SELECTION UNIT
13, 23, 33, 43 SECTION ESTIMATION UNIT
14, 24, 34, 44 STORAGE UNIT
EVT EVENT SECTION INFORMATION
F, F_{L}, F_{S} OPTICAL FIBER
INF SIGNAL PROCESSING CONDITIONS
SIG_{L} LONG GAUGE LENGTH SECTION SIGNAL GROUP INFORMATION
SIG_{S} SHORT GAUGE LENGTH SECTION SIGNAL GROUP INFORMATION
TAB GAUGE CORRESPONDENCE INFORMATION

What is claimed is:

1. A processing apparatus, comprising:
a signal acquisition unit configured to acquire a plurality of signal groups acquired based on backscattered light from a plurality of long gauge length sections and a plurality of signal groups acquired based on backscattered light from a plurality of short gauge length sections, which are set in an optical fiber used for distributed acoustic sensing;
a signal selection unit configured to select a long gauge length section based on a first signal feature of each of signal groups of the plurality of long gauge length sections and select a plurality of short gauge length sections corresponding to the selected long gauge length section; and
a section estimation unit configured to determine one short gauge length section, as a section in which an event has occurred, based on a second signal feature of each of signal groups of the plurality of selected short gauge length sections.

2. The processing apparatus according to claim 1, wherein the signal selection unit compares each signal of the plurality of selected short gauge length sections with a signal of the selected long gauge length section, and determines a short gauge length section having a signal closest to the signal of the selected long gauge length section as a section in which the event has occurred.

3. The processing apparatus according to claim 2, wherein the signal selection unit uses, as the signal, any one of a time waveform signal, a waveform signal obtained by applying a frequency filter to the time waveform signal, a waveform signal obtained by performing processing for suppressing noise of the time waveform signal, a signal obtained by Fourier transforming the time waveform signal, a signal obtained by converting the time waveform signal by Constant Q Conversion (CQT), and a spectrogram acquired from the time waveform signal.

4. The processing apparatus according to claim 1, wherein the signal selection unit determines a section in which the event has occurred based on a principal component obtained by performing principal component analysis on a time waveform signal of each of the plurality of selected short gauge length sections or a waveform signal obtained by converting the time waveform signal or based on a Mel frequency cepstral coefficient of the time waveform signal of each of the plurality of selected short gauge length sections or a waveform signal obtained by converting the time waveform signal.

5. The processing apparatus according to claim 1, wherein the signal selection unit selects a long gauge length section whose first signal feature is larger than a first threshold value.

6. The processing apparatus according to claim 1, wherein the signal selection unit determines one of the plurality of selected short gauge length sections having a maximum first signal feature as a section in which the event has occurred.

7. The processing apparatus according to claim 1, wherein
the signal selection unit
selects a long gauge length section whose first signal feature is larger than a first threshold value, and
determines one of the plurality of selected short gauge length sections having a maximum first signal feature as a section in which the event has occurred.

8. The processing apparatus according to claim 1, wherein
the plurality of long gauge length sections are set in a first optical fiber, and
the plurality of short gauge length sections are set in a second optical fiber having a path that is the same as or close to that of the first optical fiber.

9. The processing apparatus according to claim 1, wherein
the signal acquisition unit
acquires a signal group by setting one the plurality of long gauge length sections and the plurality of short gauge length sections in one optical fiber, and
acquires a signal group of the other of the plurality of long gauge length sections and the plurality of short gauge length sections by performing predetermined signal processing on the acquired signal group.

10. The processing apparatus according to claim 1, wherein
the signal acquisition unit alternately performs processing for acquiring signal groups of the plurality of long gauge length sections by setting the plurality of long gauge length sections in one optical fiber and processing for acquiring signal groups of the plurality of short gauge length sections by setting the plurality of short gauge length sections in the one optical fiber.

11. The processing apparatus according to claim 1, wherein
after a section in which the event has occurred is determined,
two adjacent long gauge length sections including the section in which the event has occurred are searched for,
when signals of the two adjacent long gauge length sections are similar, a plurality of corresponding short gauge length sections are selected for each of the two adjacent long gauge length sections,
one short gauge length section is selected as an event section candidate based on a second signal feature of each signal group of the plurality of selected short gauge length sections,
a similarity indicating a degree of similarity between a signal of a first long gauge length section, which is one of the two adjacent long gauge length sections, and a signal of an event candidate of the first long gauge length section is compared with a similarity indicating a degree of similarity between a signal of a second long gauge length section, which is the other of the two adjacent long gauge length sections, and a signal of an event candidate of the second long gauge length section, and
instead of the section in which the event has occurred of the first and second long gauge length sections, the event candidate of a long gauge section having the larger similarity is newly determined as a section in which the event has occurred.

12. The processing apparatus according claim 1, wherein
after a section in which the event has occurred is determined,
two adjacent long gauge length sections including the section in which the event has occurred are searched for,
one short gauge length section close to the other long gauge length section is selected from each of the two adjacent long gauge length sections,
when signals of two short gauge length sections selected from the two adjacent long gauge length sections are similar, a plurality of corresponding short gauge length sections are selected for each of the two adjacent long gauge length sections,
one short gauge length section is selected as an event section candidate based on a signal feature of each signal group of the plurality of selected short gauge length sections,
a similarity indicating a degree of similarity between a signal of a first long gauge length section, which is one of the two adjacent long gauge length sections, and a signal of an event candidate of the first long gauge length section is compared with a similarity indicating a degree of similarity between a signal of a second long gauge length section, which is the other of the two adjacent long gauge length sections, and a signal of an event candidate of the second long gauge length section, and
instead of an event occurrence section of the first and second long gauge length sections, the event candidate of a long gauge section having the larger similarity is newly determined as a section in which the event has occurred.

13. A distributed acoustic sensing system, comprising:
an optical fiber used for sensing;
a detection unit configured to output a light pulse to the optical fiber and monitor backscattered light of the light pulse; and
a processing apparatus configured to receive a monitoring result of the backscattered light in the detection unit,
wherein the processing apparatus includes:
a signal acquisition unit configured to acquire a plurality of signal groups acquired based on backscattered light from a plurality of long gauge length sections and a plurality of signal groups acquired based on backscattered light from a plurality of short gauge length sections, which are set in the optical fiber;
a signal selection unit configured to select a long gauge length section based on a first signal feature of each of signal groups of the plurality of long gauge length sections and select a plurality of short gauge length sections corresponding to the selected long gauge length section; and
a section estimation unit configured to determine one short gauge length section, as a section in which an event has occurred, based on a second signal feature of each of signal groups of the plurality of selected short gauge length sections.

14. A distributed acoustic sensing method, comprising:
acquiring a plurality of signal groups acquired based on backscattered light from a plurality of long gauge length sections and a plurality of signal groups acquired based on backscattered light from a plurality of short gauge length sections, which are set in an optical fiber used for distributed acoustic sensing;
selecting a long gauge length section based on a first signal feature of each of signal groups of the plurality of long gauge length sections and selecting a plurality of short gauge length sections corresponding to the selected long gauge length section; and
determining one short gauge length section, as a section in which an event has occurred, based on a second signal feature of each of signal groups of the plurality of selected short gauge length sections.

15. (canceled)
